(19) United States
(12) Patent Application Publication
(10) Pub. No.: US 2026/0250490 A1
(43) Pub. Date: Aug. 27, 2026

(54) RUBBER COMPOSITION COMPRISING A HIGHLY SATURATED DIENE ELASTOMER

(71) Applicant: COMPAGNIE GENERALE DES ETABLISSEMENTS MICHELIN, Clermont-Ferrand (FR)

(72) Inventors: THOMAS FERRAND, Clermont-Ferrand (FR); JOSE-CARLOS ARAUJO DA SILVA, Clermont-Ferrand (FR); MAXIME PRAS, Clermont-Ferrand (FR); FLORA DESCOMBES, Clermont-Ferrand (FR); FRANCOIS LALLET, Clermont-Ferrand (FR)

(21) Appl. No.: 18/874,768

(22) PCT Filed: Jun. 19, 2023
(86) PCT No.: PCT/EP2023/066383

§ 371 Date: Dec. 13, 2024

(30) Foreign Application Priority Data
Jun. 21, 2022 (FR) FR2206087

(51) Int. Cl. C08L 7/00; B60C 1/00

(52) U.S. Cl. CPC C08L 7/00; B60C 1/0025; C08L 2312/00

(57) ABSTRACT

A rubber composition having improved tear strength is based on 20 to 50 phr of copolymer containing ethylene units and 1,3-diene units, the ethylene units in the copolymer representing between 50 mol % and 95 mol % of the monomer units of the copolymer; 50 to 80 phr of polyisoprene comprising a mass content of 1,4-cis bonds of at least 90% of the mass of the polyisoprene; a filler comprising from 11 to 56 phr of carbon black and from 4 to 24 phr of silica, the weight of silica being less than or equal to 30% by weight relative to the total weight of carbon black and silica; and a vulcanization system. Rubber articles comprise such a rubber composition, in particular pneumatic tires, at least one sidewall of which comprises such a rubber composition.

The field of the present invention is that of rubber compositions comprising a highly saturated diene elastomer, in particular compositions intended for use in a tyre, preferably in tyre sidewalls.

The sidewalls of a tyre are exposed both to the action of ozone and to cycles of deformation such as bending during the running of the tyre. The deformation cycles combined with the action of ozone can cause cracks or fissures to appear in the sidewall, preventing the use of the tyre regardless of the wear of the tread. Consequently, rubber compositions are sought which are very cohesive in order to constitute, for example, tyre sidewalls by virtue of their capacity to undergo large deformations without breaking, even in the presence of crack initiations.

To minimize the action of ozone on rubber compositions, it is known to use copolymers exhibiting less sensitivity to oxidation, such as, for example, highly saturated diene elastomers, elastomers comprising ethylene units at a molar content of greater than 50% of the monomer units of the elastomer. The use of copolymers of ethylene and of 1,3-diene in a composition for sidewalls is also, for example, described in document EP 2 682 423 A1 for increasing resistance to ozone. Nevertheless, a deterioration of the cohesion properties of the rubber composition occurs as soon as the molar content of ethylene in the copolymer is greater than 50%.

Moreover, diene rubber compositions comprising copolymers of ethylene and of 1,3-butadiene, once crosslinked, can exhibit a much higher stiffness than the diene rubber compositions conventionally used, as emerges from document WO 2014/114607 A1. However, this increased stiffness, although favourable to improved wear resistance for use in a tread, may sometimes prove to be unsuitable for certain applications.

It has thus been sought to reduce the stiffness in the cured state of such compositions comprising an ethylene-based diene rubber. For this, it is known practice to reduce the bridging density of the rubber composition. However, this solution is accompanied by an increase in the hysteresis of the rubber composition, which is detrimental to the rolling resistance. Document WO 2021/053296 A1 provided a solution which makes it possible to reduce the stiffness in the cured state of compositions comprising an ethylene-based diene rubber without damaging the hysteresis, by using rubber compositions which comprise a copolymer of ethylene and of a 1,3-diene of formula CH₂═CR—CH═CH₂, the symbol R representing a hydrocarbon chain containing 3 to 20 carbon atoms.

It would thus be advantageous for tyre manufacturers to have available rubber compositions which can be used in particular in sidewalls, exhibiting a compromise in performance qualities, namely the resistance to crack propagation, the stiffness and the hysteresis, which are improved, in particular by improving resistance to crack propagation, preferably by also decreasing stiffness and without being too damaging to the hysteresis of the composition, or even improving it.

Continuing its research studies, the applicant has discovered, unexpectedly, that the combined use of carbon black and silica, in particular proportions, in a composition based on a specific copolymer containing ethylene units and a 1,3-diene makes it possible to solve the abovementioned technical problem.

Thus, a subject of the invention is a rubber composition based on at least:
20 to 50 phr of at least one copolymer containing ethylene units and 1,3-diene units, the ethylene units in the copolymer representing between 50 mol % and 95 mol % of the monomer units of the copolymer;
50 to 80 phr of polyisoprene comprising a mass content of 1,4-cis bonds of at least 90% of the mass of the polyisoprene;
a filler comprising from 11 to 56 phr of carbon black and from 4 to 24 phr of silica, the weight of silica being less than or equal to 30% by weight relative to the total weight of carbon black and silica; and
a vulcanization system.

A subject of the invention is also a rubber article comprising a composition according to the invention, in particular a pneumatic tyre, at least one sidewall of which comprises a composition according to the invention.

### I—DEFINITIONS

The expression “based on” used to define the constituents of a catalytic system means the mixture of these constituents, or the product of the reaction of a portion or all of these constituents with each other.

The expression “composition based on” should be understood to mean a composition including the mixture and/or the product of the in situ reaction of the various constituents used, some of these constituents being able to react and/or being intended to react with one another, at least partially, during the various phases of manufacture of the composition; it thus being possible for the composition to be in the completely or partially crosslinked state or in the non-crosslinked state.

The term “elastomer matrix” means all of the elastomers of the composition, including the copolymer defined below.

Unless otherwise indicated, the contents of the units resulting from the insertion of a monomer into a copolymer are expressed as molar percentage relative to all of the monomer units of the copolymer.

For the purposes of the present invention, the expression “part by weight per hundred parts by weight of elastomer” (or phr) should be understood as meaning the part by weight per hundred parts by weight of the elastomer matrix.

Furthermore, any interval of values denoted by the expression “between a and b” represents the range of values extending from more than a to less than b (i.e. limits a and b excluded), whereas any interval of values denoted by the expression “from a to b” means the range of values extending from a up to b (i.e. including the strict limits a and b). In the present document, when an interval of values is denoted by the expression “from a to b”, the interval represented by the expression “between a and b” is also and preferentially denoted.

When reference is made to a “predominant” compound, this is understood to mean, for the purposes of the present invention, that this compound is predominant among the compounds of the same type in the composition, that is to say that it is the one which represents the greatest amount by weight among the compounds of the same type. Thus, for example, a predominant elastomer is the elastomer representing the greatest weight relative to the total weight of the elastomers in the composition. In the same way, a “predominant” filler is that representing the greatest weight among the fillers of the composition. By way of example, in a system comprising only one elastomer, the latter is predominant for the purposes of the present invention, and in a system comprising two elastomers, the predominant elastomer represents more than half of the weight of the elastomers. In contrast, a “minor” compound is a compound which does not represent the greatest fraction by weight among the compounds of the same type. Preferably, the term “predominant” means present to more than 50%, preferably more than 60%, 70%, 80%, 90%, and more preferentially the “predominant” compound represents 100%.

The compounds mentioned in the description may be of fossil origin or may be biobased. In the latter case, they can result, partially or completely, from biomass or be obtained, partially or completely, from renewable starting materials resulting from biomass. Similarly, the compounds mentioned may also originate from the recycling of already-used materials, i.e. they may partially or completely result from a recycling process, or else be obtained from starting materials which themselves result from a recycling process. This particularly concerns polymers, plasticizers, fillers, etc.

Unless otherwise indicated, all the glass transition temperature “Tg” values described herein are measured in a known manner by DSC (Differential Scanning calorimetry) according to the standard ASTM D3418 (1999).

### II—DESCRIPTION OF THE INVENTION

### II-1 Elastomer Matrix

The composition according to the invention is based on at least:
20 to 50 phr of at least one copolymer containing ethylene units and 1,3-diene units, the ethylene units in the copolymer representing between 50 mol % and 95 mol % of the monomer units of the copolymer (hereinafter referred to as “the copolymer”);
50 to 80 phr of polyisoprene containing a mass content of 1,4-cis bonds of at least 90% of the mass of the polyisoprene.

The expression “copolymer containing ethylene units and 1,3-diene units” is understood to mean any copolymer comprising, within its structure, at least ethylene units and 1,3-diene units. According to the invention, the 1,3-diene can be a single compound, that is to say one 1,3-diene or be a mixture of 1,3-dienes.

The copolymer may also comprise monomer units other than the ethylene units and 1,3-diene units, but this is not preferred. For example, the copolymer may also comprise α-olefin units, notably α-olefin units having from 3 to 18 carbon atoms, advantageously having 3 to 6 carbon atoms. For example, the α-olefin units may be selected from the group consisting of propylene, butene, pentene, hexene or mixtures thereof.

In a known way, the expression “ethylene unit” refers to the —(CH₂—CH₂)— unit resulting from the insertion of ethylene into the elastomer chain.

In a known manner, the expression “1,3-diene unit” refers to units resulting from the insertion of the 1,3-diene via a 1,4 addition, a 1,2 addition or a 3,4 addition in the case of a substituted diene such as isoprene for example.

Preferably, the 1,3-diene units are selected from the group consisting of butadiene units, isoprene units and mixtures of these 1,3-diene units. In particular, the 1,3-diene units of the copolymer may be 1,3-diene units having 4 to 24 carbon atoms, for example 1,3-butadiene, 2-methyl-1,3-butadiene (or isoprene) units or units of formula CH₂═CR—CH═CH₂, the symbol R representing a hydrocarbon chain having 3 to 20 carbon atoms.

The copolymer that is useful for the purposes of the invention is advantageously a random copolymer according to any one of the embodiments of the invention. Very advantageously, the copolymer is an atactic polymer according to any one of the embodiments of the invention.

Preferably, the copolymer has a glass transition temperature below −35° C., preferably between −90° C. and −35° C., more preferably between −70° C. and −35° C.

Advantageously also, the copolymer contains ethylene units which represent from 60 mol % to 90 mol % of the monomer units of the copolymer, that is to say from 60 mol % to 90 mol % of the ethylene units and of the 1,3-diene units. Very preferentially, the copolymer contains ethylene units which represent from 70 mol % to 85 mol % of the monomer units of the copolymer.

Particularly advantageously, the copolymer is a copolymer containing ethylene units and units of a 1,3-diene of formula (I), the ethylene units in the copolymer representing between 50 mol % and 95 mol % of the units CH₂═CR—CH═CH₂ (I), the symbol R representing a hydrocarbon chain containing 3 to 20 carbon atoms.

The 1,3-diene of formula (I) is a substituted 1,3-diene, which can give rise to units of 1,2 configuration represented by formula (I), of 3,4 configuration represented by formula (2) and of 1,4 configuration, the trans form of which is represented below by formula (3).

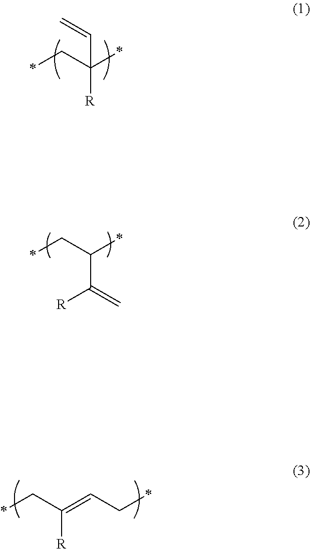

In formula (I) of the 1,3-diene, the hydrocarbon chain represented by the symbol R is an unsaturated chain of 3 to 20 carbon atoms. Preferably, the symbol R represents a hydrocarbon chain containing from 6 to 16 carbon atoms.

The hydrocarbon chain represented by the symbol R may be a saturated or unsaturated chain. Preferably, the symbol R represents an aliphatic chain, in which case in formula (I) of the 1,3-diene, the hydrocarbon chain represented by the symbol R is an aliphatic hydrocarbon chain. It can be a linear or branched chain, in which case the symbol R represents a linear or branched chain. Preferably, the hydrocarbon chain is acyclic, in which case the symbol R represents an acyclic chain. More preferably, the symbol R represents an unsaturated and branched acyclic hydrocarbon chain. Thus, the hydrocarbon chain represented by the symbol R is advantageously an unsaturated and branched acyclic chain containing from 3 to 20 carbon atoms, in particular from 6 to 16 carbon atoms. Very advantageously, the 1,3-diene is myrcene, β-farnesene or a mixture of myrcene and β-farnesene. Even more advantageously, the 1,3-diene is myrcene.

Advantageously, the copolymer contains units of the 1,3-diene of formula (I) which represent between 10 mol % and 40 mol %, preferably between 15 mol % and 30 mol %, of the monomer units of the copolymer.

The copolymer containing ethylene units and units of a 1,3-diene of formula (I) may comprise a second 1,3-diene selected from 1,3-butadiene, isoprene or a mixture thereof. In this case, the copolymer is a copolymer of ethylene, of a 1,3-diene of formula (I) and of a second 1,3-diene selected from 1,3-butadiene, isoprene or a mixture thereof, the monomer units of the copolymer are units resulting from the polymerization of ethylene, of the 1,3-diene of formula (I) and of the second 1,3-diene. The copolymer may thus comprise ethylene units, units of the 1,3-diene of formula (I) and units of the second 1,3-diene. Advantageously, the second 1,3-diene of the copolymer is 1,3-butadiene.

When the copolymer containing ethylene units and units of a 1,3-diene of formula (I) contains units of the second 1,3-diene, said units advantageously represent between 1 mol % and 49 mol %, preferably between 4 mol % and 29 mol %, preferably between 4 mol % and 25 mol %, of the monomer units of the copolymer.

According to one embodiment of the invention, the copolymer contains more than 60 mol % to 90 mol % of ethylene units and not more than 20 mol %, preferentially not more than 15 mol %, of units of the 1,3-diene of formula (I). According to this embodiment of the invention, the copolymer preferentially contains less than 30 mol % of units of the second 1,3-diene or preferentially contains less than 20 mol % of units of the second 1,3-diene.

When the second 1,3-diene is 1,3-butadiene or a mixture of 1,3-butadiene and isoprene, the copolymer can also contain units of 1,2-cyclohexanediyl moieties. The presence of these cyclic structures in the copolymer results from a very particular insertion of ethylene and 1,3-butadiene during the polymerization. The content of units of 1,2-cyclohexanediyl moieties in the copolymer varies according to the respective contents of ethylene and 1,3-butadiene in the copolymer. The copolymer preferably contains less than 15 mol % of units of 1,2-cyclohexanediyl moiety.

The copolymer containing ethylene units and units of a 1,3-diene of formula (I) may be prepared via a process which comprises the copolymerization of ethylene, of the 1,3-diene of formula (I) and of the optional second 1,3-diene, in the presence of a catalytic system based at least on a metallocene of formula (II) and on an organomagnesium compound of formula (III)

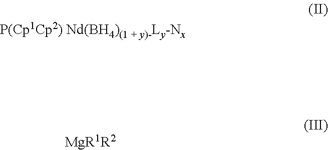

where:
Cp¹ and Cp², which may be identical or different, being selected from the group consisting of the cyclopentadienyl of formula C₅H₄, the unsubstituted fluorenyl group of formula C₁₃H₈ and substituted fluorenyl groups,
P being a group bridging the two Cp¹ and Cp² groups and representing a ZR³R⁴ group, Z representing a silicon or carbon atom, R³ and R⁴, which may be identical or different, each representing an alkyl group comprising from 1 to 20 carbon atoms, preferably a methyl,
y, an integer, being greater than or equal to 0,
x, an integer or non-integer, being greater than or equal to 0,
L representing an alkali metal selected from the group consisting of lithium, sodium and potassium,
N representing a molecule of an ether, preferably diethyl ether or tetrahydrofuran,
R₁ and R₂, which may be identical or different, representing a carbon-based group.

Mention may be made, as substituted fluorenyl groups, of those substituted by alkyl radicals having from 1 to 6 carbon atoms or by aryl radicals having from 6 to 12 carbon atoms. The choice of the radicals is also guided by the accessibility to the corresponding molecules, which are the substituted fluorenes, because the latter are commercially available or can be easily synthesized.

Substituted fluorenyl groups include the 2,7-di(tert-butyl) fluorenyl and 3,6-di(tert-butyl) fluorenyl groups. Positions 2, 3, 6 and 7 respectively denote the positions of the carbon atoms of the rings as represented in the diagram below, position 9 corresponding to the carbon atom to which the bridge P is attached.

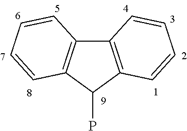

The catalytic system can be prepared conventionally by a process analogous to that described in patent application WO 2007/054224 or WO 2007/054223. For example, the organomagnesium reagent and the metallocene are reacted in a hydrocarbon-based solvent typically at a temperature ranging from 20° C. to 80° C. for a period of time of between 5 and 60 minutes. The catalytic system is generally prepared in an aliphatic hydrocarbon-based solvent such as methylcyclohexane, or an aromatic hydrocarbon-based solvent such as toluene. Generally, after its synthesis, the catalytic system is used as is in the process for the synthesis of the copolymer in accordance with the invention.

Alternatively, the catalytic system can be prepared by a process analogous to that described in patent application WO 2017/093654 A1 or in patent application WO 2018/020122 A1. According to this alternative, the catalytic system also contains a preformation monomer selected from a conjugated diene, ethylene or a mixture of ethylene and a conjugated diene, in which case the catalytic system is based at least on the metallocene, the organomagnesium reagent and the preformation monomer. For example, the organomagnesium reagent and the metallocene are reacted in a hydrocarbon-based solvent typically at a temperature of from 20° C. to 80° C. for 10 to 20 minutes to obtain a first reaction product, and the preformation monomer, selected from a conjugated diene, ethylene or a mixture of ethylene and a conjugated diene, is then reacted with this first reaction product at a temperature ranging from 40° C. to 90° C. for 1 hour to 12 hours. The conjugated diene, as preformation monomer, is preferably a 1,3-diene such as 1,3-butadiene, isoprene or a 1,3-diene of formula (I), in particular myrcene or β-farnesene. The catalytic system thus obtained can be used immediately in the process in accordance with the invention or can be stored under an inert atmosphere before the use thereof in the process in accordance with the invention.

The metallocene used for preparing the catalytic system can be in the form of a crystalline or non-crystalline powder, or else in the form of single crystals. The metallocene can be provided in a monomer or dimer form, these forms depending on the method of preparation of the metallocene, as is described, for example, in patent application WO 2007/054224 or WO 2007/054223. The metallocene may be prepared conventionally by a process analogous to that described in patent application WO 2007/054224 or WO 2007/054223, notably by reaction, under inert and anhydrous conditions, of the salt of an alkali metal of the ligand with a rare-earth metal borohydride in a suitable solvent, such as an ether, for instance diethyl ether or tetrahydrofuran, or any other solvent known to a person skilled in the art. After reaction, the metallocene is separated from the reaction byproducts via techniques known to a person skilled in the art, such as filtration or precipitation from a second solvent. The metallocene is finally dried and isolated in solid form.

Like any synthesis carried out in the presence of an organometallic compound, the synthesis of the metallocene and that of the catalytic system take place under anhydrous conditions in an inert atmosphere. Typically, the reactions are performed starting with anhydrous solvents and compounds under anhydrous nitrogen or argon.

The organomagnesium reagent that is useful for the purposes of the invention is of formula MgR¹R² where R¹ and R², which may be identical or different, represent a carbon-based group. The term “carbon-based group” means a group which contains one or more carbon atoms. Preferably, R¹ and R² contain from 2 to 10 carbon atoms. More preferentially, R¹ and R² each represent an alkyl. The organomagnesium reagent is advantageously a dialkylmagnesium compound, better still butylethylmagnesium or butyloctylmagnesium, even better still butyloctylmagnesium.

According to any one of the embodiments of the invention, the mole ratio of the organomagnesium reagent to the metal Nd constituting the metallocene is preferably within a range extending from 1 to 100, and more preferentially is greater than or equal to 1 and less than 10. The range of values extending from 1 to less than 10 is notably more favourable for obtaining copolymers of high molar masses.

When the copolymer that is useful for the purposes of the invention is a copolymer which has a microstructure as defined according to the first variant of the invention, it is prepared according to the process mentioned in the present patent application using a metallocene of formula (II) where Cp¹ and Cp², which may be identical or different, are selected from the group consisting of substituted fluorenyl groups and the unsubstituted fluorenyl group of formula C₁₃H₈. For this variant, the metallocenes of the following formulae, where the symbol Flu presents the fluorenyl group of formula C₁₃H₈, are particularly suitable: [{Me₂SiFlu₂Nd(μ-BH₄)₂Li(THF)}₂]; [Me₂SiFlu₂Nd(μ-BH₄)₂Li(THF)]; [Me₂SiFlu₂Nd(μ-BH₄)(THF)]; [{Me₂SiFlu₂Nd(μ-BH₄)(THF)}₂]; [Me₂SiFlu₂Nd(μ-BH₄)].

A person skilled in the art also knows how to adapt the polymerization conditions and the concentrations of each of the reagents (constituents of the catalytic system, monomers) according to the equipment (tools, reactors) used to perform the polymerization and the various chemical reactions. As is known to a person skilled in the art, the copolymerization and the handling of the monomers, of the catalytic system and of the polymerization solvent(s) take place under anhydrous conditions and under an inert atmosphere. The polymerization solvents are typically aliphatic or aromatic hydrocarbon-based solvents.

The polymerization is preferably performed in solution, continuously or batchwise. The polymerization solvent can be an aromatic or aliphatic hydrocarbon-based solvent. Examples of polymerization solvents that may be mentioned include toluene and methylcyclohexane. The monomers can be introduced into the reactor containing the polymerization solvent and the catalytic system or, conversely, the catalytic system can be introduced into the reactor containing the polymerization solvent and the monomers. The copolymerization is typically performed under anhydrous conditions and in the absence of oxygen, in the optional presence of an inert gas. The polymerization temperature generally varies within a range extending from 30 to 150° C., preferentially from 30 to 120° C. Preferably, the copolymerization is performed at a constant pressure of ethylene.

During the polymerization of ethylene, of the 1,3-diene of formula (I) and of the optional second 1,3-diene in a polymerization reactor, ethylene and the 1,3-diene of formula (I) and the optional second 1,3-diene may be added continuously to the polymerization reactor, in which case the polymerization reactor is a fed reactor. This embodiment is most particularly suitable for the synthesis of a random copolymer.

The polymerization can be stopped by cooling the polymerization medium. The polymer can be recovered according to conventional techniques known to a person skilled in the art, for instance by precipitation, by evaporation of the solvent under reduced pressure or by steam stripping.

The copolymer may also be a copolymer of ethylene and of a 1,3-diene (preferably 1,3-butadiene), that is to say a copolymer consisting exclusively of ethylene units and of 1,3-diene (preferably 1,3-butadiene) units.

When the copolymer is a copolymer of ethylene and of a 1,3-diene, said copolymer advantageously contains units of formula (IV) and/or (V). The presence of a saturated 6-membered ring unit, 1,2-cyclohexanediyl, of formula (IV) as a monomer unit in the copolymer may result from a series of very specific insertions of ethylene and of 1,3-butadiene into the polymer chain during its growth.

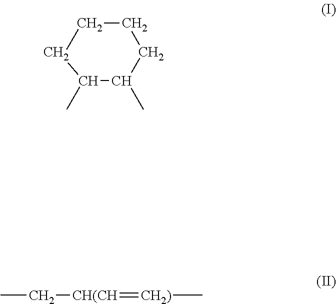

For example, the copolymer of ethylene and of a 1,3-diene may be free of units of formula (IV). In this case, it preferably contains units of formula (V).

When the copolymer of ethylene and of a 1,3-diene comprises units of formula (IV) or units of formula (V) or else units of formula (IV) and units of formula (V), the molar percentages of the units of formula (IV) and of the units of formula (V) in the copolymer, respectively o and p, preferably satisfy the following equation (eq. 1), more preferentially satisfy the equation (eq. 2), o and p being calculated on the basis of all the monomer units of the copolymer.

$$0 < o + p \leq 25 \qquad ( eq . 1 )$$

$$0 < o + p < 20 \qquad ( eq . 2 )$$

The copolymer of ethylene and of a 1,3-diene (preferably 1,3-butadiene) can be obtained according to various synthesis methods known to a person skilled in the art, notably based on the targeted microstructure of the copolymer. Generally, it may be prepared by copolymerization at least of a diene, preferably a 1,3-diene, more preferably 1,3-butadiene, and of ethylene and according to known synthesis methods, in particular in the presence of a catalytic system comprising a metallocene complex. Mention may be made, as such, of catalytic systems based on metallocene complexes, which catalytic systems are described in documents EP 1 092 731, WO 2004/035639, WO 2007/054223 and WO 2007/054224 in the name of the applicant. The copolymer, including the case when it is random, may also be prepared via a process using a catalytic system of preformed type such as those described in WO 2017/093654 A1, WO 2018/020122 A1 and WO 2018/020123 A1.

The content of the copolymer is advantageously within a range extending from 20 to 45 phr, preferably from 31 to 45 phr. It is understood that the copolymer may consist of a mixture of copolymers which differ from each other in their microstructure or their macrostructure. Furthermore, the content of polyisoprene comprising a content by weight of cis-1,4-bonds of at least 90% of the weight of the polyisoprene is advantageously within a range extending from 55 to 80 phr, preferably from 55 to 69 phr.

Advantageously, the polyisoprene comprises a content by weight of cis-1,4-bonds of at least 98% of the weight of the polyisoprene.

Preferably, the polyisoprene is selected from the group consisting of natural rubber (NR), synthetic polyisoprenes (IR), and mixtures thereof. More preferably, the polyisoprene is a natural rubber.

Particularly preferably, the total content of the copolymer and of the polyisoprene is within a range extending from 90 to 100 phr, preferably from 95 to 100 phr. Preferably, the total content of the copolymer and of the polyisoprene is 100 phr, that is to say that the copolymer and the polyisoprene are the only elastomers of the composition.

### II-2 Filler

The composition according to the invention is based on a filler comprising from 11 to 56 phr of carbon black and from 4 to 24 phr of silica, the weight of silica being less than or equal to 30% by weight relative to the total weight of carbon black and silica, preferably relative to the total weight of filler. Such fillers typically consist of nanoparticles, the (weight-) average size of which is less than a micrometer, generally less than 500 nm, usually between 20 and 200 nm, in particular and more preferentially between 20 and 150 nm.

Advantageously, the carbon black represents from 60% to 90% by weight, preferably from 65% to 80% by weight, relative to the total weight of carbon black and silica, preferably relative to the total weight of filler.

The carbon blacks which can be used in the context of the present invention are reinforcing carbon blacks well known to a person skilled in the art and conventionally used in tyres or their treads. Among said carbon blacks, mention will more particularly be made of the reinforcing carbon blacks of the 100, 200 and 300 series, or the blacks of the 500, 600 or 700 series (ASTM D-1765-2017 grades), such as, for example, the N115, N134, N234, N326, N330, N339, N347, N375, N550, N683 and N772 blacks. These carbon blacks can be used in the isolated state, as available commercially, or in any other form, for example as support for some of the rubber additives used. The carbon blacks might, for example, be already incorporated into the diene elastomer, notably an isoprene elastomer, in the form of a masterbatch (see, for example, patent applications WO 97/36724-A2 and WO 99/16600-A1).

Among the above-mentioned carbon blacks, those having a BET specific surface area within a range extending from 21 to 69 m²/g, preferably from 33 to 60 m²/g, preferably from 40 to 49 m²/g, are particularly preferred.

Advantageously, the content of carbon black (whether there is one or more thereof) in the composition according to the invention is within a range extending from 12 to 45 phr, preferably from 14 to 39 phr.

Any type of precipitated silica, notably highly dispersible silicas (HDS), is suitable for use. These precipitated silicas, which may or may not be highly dispersible, are well known to a person skilled in the art. Mention may be made, for example, of the silicas described in applications WO 03/016215-A1 and WO 03/016387-A1. Among the commercial HDS silicas, use may notably be made of the Ultrasil® 5000GR and Ultrasil® 7000GR silicas from Evonik or the Zeosil® 1085GR, Zeosil® 1115 MP, Zeosil® 1165MP, Zeosil® Premium 200MP and Zeosil® HRS 1200 MP silicas from Solvay. Use may be made, as non-HDS silica, of the following commercial silicas: the Ultrasil® VN2GR and Ultrasil® VN3GR silicas from Evonik, the Zeosil® 175GR silica from Solvay or the Hi-Sil EZ120G(-D), Hi-Sil EZ160G(-D), Hi-Sil EZ200G(-D), Hi-Sil 243LD, Hi-Sil 210 and Hi-Sil HDP 320G silicas from PPG.

Advantageously, the content of silica (whether there is one or more thereof) in the composition according to the invention is within a range extending from 5 to 19 phr, preferably from 6 to 16 phr. Advantageously likewise, the content of silica is within a range extending from 5.2 to 9.8 phr.

In order to couple the silica to the diene elastomer, use may be made, in a well-known manner, of an at least difunctional coupling agent (or bonding agent) intended to provide a satisfactory connection, of chemical and/or physical nature, between the inorganic filler (surface of its particles) and the diene elastomer. Use is made in particular of organosilanes or polyorganosiloxanes which are at least bifunctional. The term “bifunctional” is understood to mean a compound having a first functional group capable of interacting with the inorganic filler and a second functional group capable of interacting with the diene elastomer. For example, such a bifunctional compound may comprise a first functional group comprising a silicon atom, said first functional group being capable of interacting with the hydroxyl groups of an inorganic filler, and a second functional group comprising a sulfur atom, said second functional group being capable of interacting with the diene elastomer.

Preferentially, when they are used, the organosilanes are selected from the group consisting of (symmetrical or asymmetrical) organosilane polysulfides, such as bis(3-triethoxysilylpropyl) tetrasulfide, abbreviated to TESPT, sold under the name Si69 by Evonik, or bis(triethoxysilylpropyl) disulfide, abbreviated to TESPD, sold under the name Si75 by Evonik, polyorganosiloxanes, mercaptosilanes, blocked mercaptosilanes, such as S-(3-(triethoxysilyl) propyl) octanethioate, sold by Momentive under the name NXT Silane. More preferentially, the organosilane is an organosilane polysulfide.

When an agent for coupling silica to the elastomer is used, the content of coupling agent can easily be adjusted by a person skilled in the art. Typically, the content of coupling agent represents from 0.5% to 15% by weight relative to the amount of silica.

However, it is advantageous in the context of the present invention not to use a coupling agent. Thus, preferentially, the content of coupling agent, in the composition according to the invention, is advantageously less than 0.5%, preferably less than 0.3% by weight, relative to the weight of silica. More preferably, the composition according to the invention does not comprise coupling agent.

Advantageously, the composition according to the invention does not comprise any filler other than carbon black and silica or comprises less than 10 phr, preferably less than 5 phr, thereof. In a particularly advantageous manner, the composition does not comprise any filler other than carbon black and silica.

### II-3 Crosslinking System

The system for crosslinking the composition in accordance with the invention is a vulcanization system, that is to say a sulfur-based crosslinking system.

The sulfur can be contributed in any form, in particular in the form of molecular sulfur or of a sulfur-donating agent. A person skilled in the art knows how to adjust the amount of sulfur-donating agent in order to obtain the desired amount of sulfur in the composition. Preferably, the sulfur is provided in the form of molecular sulfur.

At least one vulcanization accelerator is also present, and optionally, and preferentially, use may be made of various known vulcanization activators, such as zinc oxide, stearic acid or equivalent compounds such as stearic acid salts and transition metal salts thereof, guanidine derivatives (in particular diphenylguanidine), or of known vulcanization retarders.

Sulfur is used in a preferential content of between 0.5 and 12 phr, in particular between 1 and 10 phr. The vulcanization accelerator is used in a preferential content of between 0.5 and 10 phr, more preferentially between 0.5 and 5.0 phr. More preferably, the composition comprises from 0.6 to 2 phr, preferably from 0.7 to 1.8 phr, of sulfur and from 0.6 to 1 phr, preferably from 0.6 to 0.9 phr, of at least one vulcanization accelerator.

The ratio by weight of sulfur to vulcanization accelerator may be within a range extending from 0.75 to 3.00, preferably from 1.00 to 2.75, more preferably from 1.30 to 2.33.

Use may be made, as accelerator, of any compound capable of acting as accelerator of the vulcanization of diene elastomers in the presence of sulfur, in particular accelerators of the thiazole type, and also derivatives thereof, or accelerators of sulfenamide, thiuram, dithiocarbamate, dithiophosphate, thiourea and xanthate types. Mention may in particular be made, as examples of such accelerators, of the following compounds: 2-mercaptobenzothiazyl disulfide (abbreviated to MBTS), N-cyclohexyl-2-benzothiazolesulfenamide (CBS), N,N-dicyclohexyl-2-benzothiazolesulfenamide (DCBS), N-(tert-butyl)-2-benzothiazolesulfenamide (TBBS), N-(tert-butyl)-2-benzothiazolesulfenimide (TBSI), tetrabenzylthiuram disulfide (TBZTD), zinc dibenzyldithiocarbamate (ZBEC) and the mixtures of these compounds.

Advantageously, the vulcanization accelerator is selected from accelerators of sulfenamide type and mixtures thereof, preferably selected from the group consisting of CBS, TBBS, DCBS and mixtures thereof. Particularly advantageously, the vulcanization accelerator is CBS. Advantageously, likewise, the composition does not comprise any vulcanization accelerator other than accelerators of sulfenamide type, preferably other than CBS.

### II-4 Possible Additives

The rubber compositions according to the invention may optionally also include all or some of the usual additives customarily used in elastomer compositions for tyres, for instance plasticizers (such as plasticizing oils and/or plasticizing resins), pigments, protective agents such as anti-ozone waxes, chemical anti-ozonants, antioxidants, anti-fatigue agents, etc.

### II-5 Preparation of the Rubber Compositions

The compositions that may be used in the context of the present invention may be manufactured in appropriate mixers using two successive preparation phases that are well known to a person skilled in the art:
a first phase of thermomechanical working or kneading (“non-productive” phase), that can be performed in a single thermomechanical step during which all the necessary constituents, notably the elastomeric matrix, the reinforcing filler and the optional various other additives, with the exception of the crosslinking system, are introduced into an appropriate mixer, such as a standard internal mixer (for example of Banbury type). The incorporation of the optional filler into the elastomer may be performed in one or more portions while thermomechanically kneading. If the filler is already incorporated, totally or partially, in the elastomer in the form of a masterbatch, as is described, for example, in the applications WO 97/36724 or WO 99/16600, it is the masterbatch which is directly kneaded and, where appropriate, the other elastomers or fillers present in the composition which are not in masterbatch form, and also the various other optional additives, with the exception of the crosslinking system, are incorporated. The non-productive phase can be carried out at high temperature, up to a maximum temperature of between 110° C. and 200° C., preferably between 130° C. and 185° C., for a period of time generally of between 2 and 10 minutes;
a second phase of mechanical working (“productive” phase), which can be carried out in an external mixer, such as an open mill, after cooling the mixture obtained during the first non-productive phase down to a lower temperature, typically of less than 120° C., for example between 40° C. and 100° C. The crosslinking system is then incorporated and the combined mixture is then mixed for a few minutes, for example between 5 and 15 min.

Such phases have been described, for example, in applications EP-A-0 501 227, EP-A-0 735 088, EP-A-0 810 258, WO 00/05300 or WO 00/05301.

The final composition thus obtained is then calendered, for example in the form of a sheet or of a slab, notably for laboratory characterization, or else is extruded (or co-extruded with another rubber composition) in the form of a rubber semi-finished product (or profiled element) that may be used, for example, as a tyre sidewall. These products may then be used for the manufacture of tyres, according to the techniques known to a person skilled in the art.

The composition may be either in the uncured state (before crosslinking or vulcanization) or in the cured state (after crosslinking or vulcanization), or may be a semi-finished product which can be used in a tyre.

The composition may be crosslinked in a manner known to a person skilled in the art, for example at a temperature of between 130° C. and 200° C., under pressure.

### II-6 Rubber Article

The present invention also relates to a rubber article comprising at least one composition according to the invention. Preferably, the rubber article is a tyre.

In the present invention, the term “tyre” is understood to mean a pneumatic or non-pneumatic tyre. A pneumatic tyre usually comprises two beads intended to come into contact with a rim, a crown composed of at least one crown reinforcement and a tread, two sidewalls, the tyre being reinforced by a carcass reinforcement anchored in the two beads. A non-pneumatic tyre, for its part, usually comprises a base, designed for example for mounting on a rigid rim, a crown reinforcement, ensuring the connection with a tread, and a deformable structure, such as spokes, ribs or cells, this structure being arranged between the base and the crown. Such non-pneumatic tyres do not necessarily comprise a sidewall. Non-pneumatic tyres are described, for example, in documents WO 03/018332 and FR 2 898 077. According to any one of the embodiments of the invention, the tyre according to the invention is preferentially a pneumatic tyre.

More particularly, a subject of the invention is also a tyre comprising a rubber composition according to the invention, the composition being present in at least one sidewall of the tyre. The composition according to the invention may constitute all or part of the sidewall of the tyre.

The tyre according to the invention may be intended to equip any type of vehicle, in particular motor vehicles, without any particular limitation.

### III—EXAMPLES

### III-1 Measurements and Tests Used

### III-1.1 Determination of the Microstructure of the Ethylene-Butadiene Elastomers (Elastomer E1):

The microstructure of the ethylene-butadiene copolymers is determined by ¹H NMR analysis, assisted by ¹³C NMR analysis when the resolution of the ¹H NMR spectra does not make it possible to assign and quantify all the species. The measurements are carried out using a Bruker 500 MHz NMR spectrometer at frequencies of 500.43 MHz for the observation of the protons and 125.83 MHz for the observation of the carbons. For the elastomers which are insoluble but which have the ability to swell in a solvent, an HRMAS 4 mm z-grad probe, which makes it possible to observe the protons and the carbons in proton-decoupled mode, is used. The spectra are acquired at spin speeds of 4000 Hz to 5000 Hz. For the measurements on soluble elastomers, a liquid NMR probe, which makes it possible to observe the protons and the carbons in proton-decoupled mode, is used. The insoluble samples are prepared in rotors filled with the material analysed and a deuterated solvent which makes swelling possible, in general deuterated chloroform (CDCl₃). The solvent used must always be deuterated and its chemical nature may be adapted by a person skilled in the art. The amounts of material used are adjusted so as to obtain spectra with a sufficient sensitivity and resolution. The soluble samples are dissolved in a deuterated solvent (approximately 25 mg of elastomer in 1 ml), in general deuterated chloroform (CDCl₃). The solvent or solvent blend used must always be deuterated and its chemical nature may be adapted by a person skilled in the art. In both cases (soluble sample or swollen sample): For proton NMR, a simple 30° pulse sequence is used. The spectral window is adjusted in order to observe all of the resonance lines belonging to the molecules analysed. The number of accumulations is set so as to obtain a signal-to-noise ratio that is sufficient for quantification of each unit. The recycle delay between each pulse is adapted in order to obtain a quantitative measurement. For carbon NMR, a simple 30° pulse sequence is used with proton decoupling only during the acquisition in order to avoid the “nuclear Overhauser” effects (NOE) and to remain quantitative. The spectral window is adjusted in order to observe all of the resonance lines belonging to the molecules analysed. The number of accumulations is set so as to obtain a signal-to-noise ratio that is sufficient for quantification of each unit. The recycle delay between each pulse is adapted in order to obtain a quantitative measurement. The NMR measurements are carried out at 25° C.

### III-1.2 Determination of the Microstructure of the Ethylene-Myrcene Copolymers (Elastomer E2):

The spectral characterization and the measurements of the microstructure of the ethylene-myrcene copolymers are performed by nuclear magnetic resonance (NMR) spectroscopy. Spectrometer: For these measurements, a Brüker Avance III HD 400 MHz spectrometer is used, equipped with a Bruker BBFO z-grad 5 mm cryoprobe.

Experiments: The ¹H experiments are recorded using a radiofrequency pulse with a tilt angle of 30°, the number of repetitions is 128 with a recycle delay of 5 seconds. The HSQC (Heteronuclear Single Quantum Coherence) and HMBC (Heteronuclear Multiple-Bond Correlation) ¹H-¹³C NMR correlation experiments are recorded with a number of repetitions of 128 and a number of increments of 128. The experiments are performed at 25° C.

Preparation of the sample: 25 mg of sample are dissolved in 1 mL of deuterated chloroform (CDCl₃).

Calibration of the sample: The axes of the ¹H and ¹³C chemical shifts are calibrated relative to the protonated impurity of the solvent (CHCl₃) at δ_{1H}=7.2 ppm (for the most deshielded signal) and δ_{13C}=77 ppm (for the least deshielded signal).

Spectral assignment for the copolymers of ethylene and of 1,3-myrcene: In the representations A, B and C below, the symbols R₁ and R₂ represent the points of attachment of the unit to the polymer chain. The signals of the insertion forms of the 1,3-diene A, B and C were observed on the different spectra recorded. According to S. Georges et al., (Polymer 55 (2014) 3869-3878), the signal of the —CH=group No. 8″ characteristic of form C exhibits ¹H and ¹³C chemical shifts identical to the —CH=group No. 3. The chemical shifts of the signals characteristic of the moieties A, B and C are presented in Table 1. The moieties A, B and C correspond respectively to the units of 3,4 configuration, of 1,2 configuration and of trans-1,4 configuration. The quantifications were performed from the integration of the 1D ¹H NMR spectra using the Topspin software. The integrated signals for the quantification of the various moieties are:
Ethylene: signal at 1.2 ppm corresponding to 4 protons
Total myrcene: signal No. 1 (1.59 ppm) corresponding to 6 protons
Form A: signal No. 7 (4.67 ppm) corresponding to 2 protons
Form B: signal No. 8′ (5.54 ppm) corresponding to 1 proton

The quantification of the microstructure is performed in molar percentage (molar %) as follows: Molar % of a moiety=¹H integral of a moiety×100/Σ(¹H integrals of each moiety).

TABLE 1

| δ_{1H} (ppm) | δ_{13C} (ppm) | Group |
|---|---|---|
| 5.54 | 146.4 | 8′ |
| 5.07 | 124.6 | 3 + 8″ |
| 4.97-4.79 | 112.0 | 9′ |
| 4.64 | 108.5 | 7 |
| 2.03 | 26.5 | 4 |
| 2.0-1.79 | 31.8 | 5 + 5′ + 5″ |
| | 44.5 | 8 |
| 1.59 | 25.9 and 17.0 | 1 |
| 1.2 | 36.8-24.0 | CH₂ ethylene |

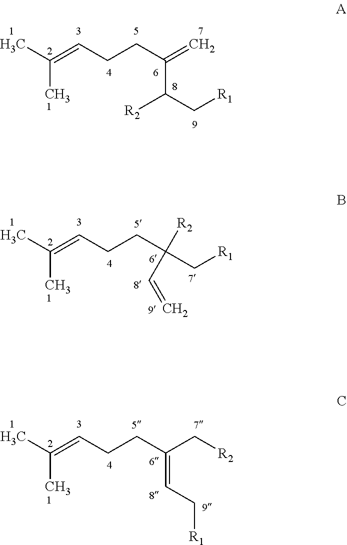

### III-1.3 Determination of the Macrostructure of the Polymers by Size Exclusion Chromatography (SEC) (Elastomers E1 and E2):

### a) Principle of the Measurement:

Size exclusion chromatography or SEC makes it possible to separate macromolecules in solution according to their size by passage through columns packed with a porous gel. The macromolecules are separated according to their hydrodynamic volume, the bulkiest being eluted first.

Combined with three detectors (3D), a refractometer, a viscometer and a 90° light-scattering detector, SEC makes it possible to comprehend the distribution of the absolute molar masses of a polymer. The various number-average (Mn) and weight-average (Mw) absolute molar masses and the polydispersity index (PI=Mw/Mn) can also be calculated.

### b) Preparation of the Polymer:

Each sample is dissolved in tetrahydrofuran at a concentration of about 1 g/l. The solution is then filtered through a filter with a porosity of 0.45 μm before injection.

### c) 3D Sec Analysis:

In order to determine the number-average molar mass (Mn), and where appropriate the weight-average molar mass (Mw) and the polydispersity index (PDI), of the polymers, the method below is used.

The number-average molar mass (Mn), the weight-average molar mass (Mw) and the polydispersity index of the polymer (hereinafter sample) are determined in an absolute way by triple detection size exclusion chromatography (SEC). Triple detection size exclusion chromatography has the advantage of measuring average molar masses directly without calibration.

The value of the refractive index increment dn/dc of the solution of the sample is measured on-line using the area of the peak detected by the refractometer (RI) of the liquid chromatography equipment. To apply this method, it must be verified that 100% of the sample mass is injected and eluted through the column. The area of the RI peak depends on the concentration of the sample, on the constant of the RI detector and on the value of the dn/dc.

In order to determine the average molar masses, use is made of the 1 g/l solution previously prepared and filtered, which is injected into the chromatographic system. The apparatus used is a Waters Alliance chromatographic line. The elution solvent is tetrahydrofuran containing 250 ppm of BHT (2,6-di(tert-butyl)-4-hydroxytoluene), the flow rate is 1 ml·min⁻¹, the temperature of the system is 35° C. and the analysis time is 60 min. The columns used are a set of three Agilent columns of PL Gel Mixed B LS trade name. The volume of the sample solution injected is 100 μl. The detection system is composed of a Wyatt differential viscometer of Viscostar II trade name, of a Wyatt differential refractometer of Optilab T-Rex trade name of wavelength 658 nm and of a Wyatt multi-angle static light scattering detector of wavelength 658 nm and of Dawn Heleos 8+ trade name.

For the calculation of the number-average molar masses and the polydispersity index, the value of the refractive index increment dn/dc of the solution of the sample obtained above is integrated. The software for processing the chromatographic data is the Astra system from Wyatt.

### III-1.4 Dynamic Properties

The dynamic properties G′ (10%) and G″ max are measured at a temperature of 23° C. on a viscosity analyser (Metravib VA4000) according to the standard ASTM D 5992-96. The response of a sample of crosslinked composition (cylindrical test specimen with a thickness of 4 mm and a cross section of 400 mm²), subjected to a simple alternating sinusoidal shear stress, at a frequency of 10 Hz, under defined temperature conditions, for example at 23° C., according to the standard ASTM D 1349-99, is recorded. A strain amplitude sweep is performed from 0.1% to 50% (outward cycle) and then from 50% to 0.1% (return cycle). The results made use of are the dynamic shear modulus G′ and the viscous modulus G″. The maximum value of G″ observed, denoted G″ max, and also the dynamic shear modulus G′ (10%) at 10% strain, at 23° C., are shown for the return cycle.

It is recalled that, as is well known to a person skilled in the art, the value of G′ (10%) at 23° C. is representative of the stiffness of the material. The G′ (10%) performance results at 23° C. are expressed in base 100, the value 100 being assigned to the control. For G′ (10%) at 23° C., a result greater than 100 indicates that the composition of the example in question is less stiff, reflecting better endurance for a tyre sidewall undergoing an imposed deformation.

It is also recalled that, as is well known to a person skilled in the art, the value of G″max at 23° C. is representative of the hysteresis of the material. The G″max performance results at 23° C. are expressed in base 100, the value 100 being assigned to the control. For G″max at 23° C., a result greater than 100 indicates that the composition of the example in question is less hysteretic, reflecting a lower rolling resistance for a tyre sidewall undergoing an imposed deformation.

### III-1.5 Tearability

The tearability indices are measured at 60° C. In particular, the force to be exerted in order to obtain breaking (FRD, in MPa (in N/mm²)) is determined and the strain at break (DRD, in %) is measured on a test specimen with dimensions of 10×85×2.5 mm notched at the centre of its length with 3 notches over a depth of 3 mm, in order to bring about breaking of the test specimen. Thus, the energy for bringing about breaking (breaking energy) of the test specimen, which is the product of the FRD and DRD, can be determined.

### III-2 Synthesis of the Polymers:

In the synthesis of polymers, all the reagents are obtained commercially except for the metallocenes. The butyloctylmagnesium BOMAG (20% in heptane, C=0.88 mol·l⁻¹) is obtained from Chemtura and is stored in a Schlenk tube under an inert atmosphere. The ethylene, of N35 grade, originates from Air Liquide and is used without prior purification. The myrcene (purity≥95%) is obtained from Sigma-Aldrich.

### III-2.1 Synthesis of the Copolymer E1:

In the synthesis of polymers, all the reagents are obtained commercially except for the metallocenes. The butyloctylmagnesium BOMAG (20% in heptane, C=0.88 mol·l⁻¹) is obtained from Chemtura and is stored in a Schlenk tube under an inert atmosphere. The ethylene, of N35 grade, originates from Air Liquide and is used without prior purification.

The copolymer of ethylene and of 1,3-butadiene: elastomer E1 (in accordance with the invention) is synthesized according to the procedure described below.

To a reactor containing, at 80° C., methylcyclohexane, and also ethylene (Et) and butadiene (Bd) in the proportions indicated in Table 2, butyloctylmagnesium (BOMAG) is added to neutralize the impurities in the reactor, then the catalytic system is added (see Table 2). At this moment, the reaction temperature is regulated at 80° C. and the polymerization reaction starts. The polymerization reaction takes place at a constant pressure of 8 bar. The reactor is fed throughout the polymerization with ethylene and butadiene (Bd) in the proportions defined in Table 2. The polymerization reaction is stopped by cooling, degassing the reactor and adding ethanol. An antioxidant is added to the polymer solution. The copolymer is recovered by drying in a vacuum oven to constant weight. The catalytic system is a preformed catalytic system. It is prepared in methylcyclohexane starting from a metallocene, [Me₂SiFlu₂Nd(μ-BH₄)₂Li(THF)], from a cocatalyst, butyloctylmagnesium (BOMAG), and from a preformation monomer, 1,3-butadiene, in the contents shown in Table 2. It is prepared according to a preparation method in accordance with section II. 1 of patent application WO 2017/093654 A1.

The microstructure of copolymer E1 and the properties thereof are shown in Tables 3 and 4. For the microstructure, Table 3 indicates the mole ratios of the ethylene (Eth) units, of the 1,3-butadiene units, and of the 1,2-cyclohexanediyl (ring) units.

TABLE 2

| Synthesis | E1 |
|---|---|
| Metallocene concentration (mmol/l) | 0.07 |
| Alkylating agent concentration (mmol/l) | 0.36 |
| Preformation monomer/Nd metal mole ratio | 90 |
| Feed composition (mol % Et/Bd) | 80/20 |

TABLE 3

| Elastomer | E1 |
|---|---|
| Ethylene (mol %) | 77 |
| 1,3-Butadiene (mol %) | 15 |
| 1,2-Cyclohexanediyl (mol %) | 8 |

TABLE 4

| Elastomer | E1 |
|---|---|
| Tg (° C.) | −40° C. |
| Mn (g/mol) | 142 000 |
| Mooney (ML (1 + 4)) at 100° C. | 85 (+/−8) |

### III-2.2 Synthesis of the Copolymer E2

The copolymer of ethylene and of myrcene: elastomer E2 was synthesized according to the procedure described below:

To a reactor containing, at 80° C., methylcyclohexane, and also ethylene (Et) and myrcene (Myr) in the proportions indicated in Table 6, butyloctylmagnesium (BOMAG) is added to neutralize the impurities in the reactor, followed by addition of the catalytic system (see Table 5). At this moment, the reaction temperature is regulated at 80° C. and the polymerization reaction starts. The polymerization reaction takes place at a constant pressure of 8 bar. The reactor is fed throughout the polymerization with ethylene and myrcene (Myr) in the proportions defined in Table 6. The polymerization reaction is stopped by cooling, degassing the reactor and adding ethanol. An antioxidant is added to the polymer solution. The copolymer is recovered by drying in a vacuum oven to constant weight. The catalytic system is a preformed catalytic system. It is prepared in methylcyclohexane starting from a metallocene, [Me₂SiFlu₂Nd(μ-BH₄)₂Li(THF)], from a cocatalyst, butyloctylmagnesium (BOMAG), and from a preformation monomer, 1,3-butadiene, in the contents shown in Table 5. It is prepared according to a preparation method in accordance with section II.1 of patent application WO 2017/093654 A1.

The microstructure of the elastomer E1 and the properties thereof are shown in Table 6. For the microstructure, Table 6 indicates the molar contents of the ethylene (Eth) units and of the myrcene units. Also shown therein is the molar proportion of the myrcene units according to whether they are of 1,4 configuration, 1,2 configuration or 3,4 configuration.

TABLE 5

| Synthesis | E2 |
|---|---|
| Metallocene concentration | 0.09 |
| (mmol/l) | |
| Alkylating agent concentration | 0.17 |
| (mmol/l) | |
| Preformation monomer/Nd metal mole ratio | 90 |
| Feed composition | 75/25 |
| (mol % Et/Myr) | |

TABLE 6

| Elastomer | E2 |
|---|---|
| Et (mol %) | 75 |
| Myr (mol %) | 25 |
| Myr 1,4 (mol %/mol % Myr) | 7 |
| Myr 1,2 (mol %/mol % Myr) | 1 |
| Myr 3,4 (mol %/mol % Myr) | 17 |
| Tg (° C.) | −60 |
| Mn (g/mol) | 364,000 |

### III-3 Preparation of the Compositions

In the examples that follow, the rubber compositions were produced as described in point II-5 above. In particular, the “non-productive” phase was performed in a 0.4 litre mixer for 3.5 minutes, at an average paddle speed of 50 rpm, until a maximum dropping temperature of 160° C. was reached. The “productive” phase was performed in an open mill at 23° C. for 5 minutes. The crosslinking of the composition was performed at a temperature of 150° C., under pressure, for a period of 15 minutes.

### III-3 Tests on Rubber Compositions

The examples presented below are intended to compare the tearability, stiffness and hysteresis performance qualities of three compositions in accordance with the invention (C1, C2 and C3) with two control compositions (T1 and T2).

Table 7 presents the compositions tested (in phr) and also the results obtained.

TABLE 7

| | T1 | C1 | I2 | T2 | C3 |
|---|---|---|---|---|---|
| NR (1) | 60 | 60 | 60 | 60 | 60 |
| Elastomer E1 (2) | 40 | 40 | 40 | — | — |
| Elastomer E2 (3) | — | — | — | 40 | 40 |
| Carbon black (4) | 34 | 25.5 | 25.5 | 29 | 22 |
| Silica (5) | — | 8.5 | 8.5 | — | 7 |
| Coupling agent (6) | — | — | 0.68 | — | — |
| Plasticizer 1 (7) | 20 | 20 | 20 | — | — |
| Plasticizer 2 (8) | — | — | — | 20 | 20 |
| TMQ (9) | 1 | 1 | 1 | 1 | 1 |
| Ozone wax (10) | 1 | 1 | 1 | 1 | 1 |
| 6-PPD (11) | 3 | 3 | 3 | 3 | 3 |
| ZnO (12) | 1 | 1 | 1 | 1 | 1 |
| Stearic acid (13) | 2 | 2 | 2 | 2 | 2 |
| Sulfur | 1.75 | 1.75 | 1.75 | 1.49 | 1.49 |
| CBS (14) | 0.88 | 0.88 | 0.88 | 0.75 | 0.75 |
| Stiffness | 100 | 107 | 109 | 100 | 106 |
| G′10% Return | | | | | |
| 10 Hz 23° C. | | | | | |
| Hysteresis | 100 | 111 | 114 | 100 | 96 |
| G″max Return | | | | | |
| 10 Hz 23° C. | | | | | |
| Tearability | 100 | 127 | 104 | 100 | 201 |
| Breaking energy | | | | | |
| (FDR × DRD) | | | | | |
| Compromise | 100 | 115 | 109 | 100 | 135 |

(1) Natural rubber
(2) Elastomer E1 prepared according to the process described in point III-2.1 above
(3) Elastomer E2 prepared according to the process described in point III-2.2 above
(4) Carbon black grade N550 according to the standard ASTM D-1765
(5) Solvay-Rhodia “Zeosil 1165 MP” silica in microbead form
(6) Liquid silane triethoxysilylpropyltetrasulfide (TESPT) “Si69” from Evonik
(7) Liquid plasticizer 1: Trioctyl phosphate (tri-2-ethylhexyl phosphate) “Disflamoll TOF” from Lanxess (Tg = −110° C.)
(8) Liquid plasticizer 2: “Tudalen 1968” paraffin oil from Klaus Dahleke
(9) 2,2,4-trimethyl-1,2-dihydroquinoline “Pilnox TMQ” from Nocil
(10) “Varazon 4959” anti-ozone wax from Sasol Wax
(11) “Santoflex 6-PPD” N-1,3-dimethylbutyl-N-phenylparaphenylenediamine from Flexsys
(12) Zinc oxide of industrial grade from Umicore
(13) “Pristerene 4931” stearic acid from Uniqema
(14) “Santocure CBS” N-cyclohexyl-2-benzothiazylsulfenamide from Flexsys

The results presented in Table 7 above show that the replacement of some of the carbon black with silica makes it possible to improve both the tear strength and the durability of a rubber composition based on a highly saturated diene elastomer, without being too detrimental to the rolling resistance, or even while improving the latter.

The overall compromise in terms of performance quality of resistance to tearing, endurance and rolling resistance is particularly improved when the copolymer comprises units of a 1,3-diene of formula CH₂═CR—CH═CH₂, the symbol R representing a hydrocarbon chain having 3 to 20 carbon atoms. The compromise of these performance qualities can be considered to be the arithmetic mean of the results presented in base 100.

Moreover, the comparison of the compositions C1 and C2 shows that the absence of an agent for coupling silica to the diene elastomer makes it possible to further improve the resistance to tearing, without excessively impacting the endurance and the rolling resistance, which moreover remain improved compared to the composition T1.

1.-15. (canceled)

16. A rubber composition based on at least:
20 to 50 phr of at least one copolymer containing ethylene units and 1,3-diene units, the ethylene units in the copolymer representing between 50 mol % and 95 mol % of monomer units of the copolymer;
50 to 80 phr of polyisoprene comprising a mass content of 1,4-cis bonds of at least 90% of a mass of the polyisoprene;
a filler comprising from 11 to 56 phr of carbon black and from 4 to 24 phr of silica, a weight of silica being less than or equal to 30% by weight relative to a total weight of carbon black and silica; and
a vulcanization system.

17. The rubber composition according to claim 16, wherein the copolymer contains ethylene units which represent from 60 mol % to 90 mol % of the monomer units of the copolymer.

18. The rubber composition according to claim 16, wherein the at least one copolymer containing ethylene units and 1,3-diene units, the ethylene units in the copolymer representing between 50 mol % and 95 mol % of the monomer units of the copolymer, is a copolymer containing ethylene units and units of a 1,3-diene of formula (I), the ethylene units in the copolymer representing between 50 mol % and 95 mol % of the monomer units of the copolymer, 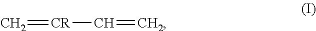
the symbol R representing a hydrocarbon chain having 3 to 20 carbon atoms.

19. The rubber composition according to claim 18, wherein the 1,3-diene of formula (I) is myrcene, β-farnesene or a mixture of myrcene and β-farnesene.

20. The rubber composition according to claim 18, wherein the copolymer contains units of the 1,3-diene of formula (I) which represent between 10 mol % and 40 mol % of the monomer units of the copolymer.

21. The rubber composition according to claim 16, wherein the copolymer content is within a range extending from 20 to 45 phr, and wherein the polyisoprene is present in a content within a range extending from 55 to 80 phr.

22. The rubber composition according to claim 16, wherein a total content of the copolymer and of the polyisoprene is within a range extending from 90 to 100 phr.

23. The rubber composition according to claim 16, wherein the polyisoprene is selected from the group consisting of natural rubber, synthetic polyisoprenes and mixtures thereof.

24. The rubber composition according to claim 16, wherein the content of carbon black is within a range from 12 to 45 phr.

25. The rubber composition according to claim 16, wherein the content of silica is within a range extending from 5 to 19 phr.

26. The rubber composition according to claim 16, wherein the carbon black represents from 60% to 90% by weight relative to the total weight of carbon black and silica.

27. The rubber composition according to claim 16, wherein the rubber composition does not comprise a filler other than carbon black and silica or comprises less than 10 phr of a filler other than carbon black and silica.

28. The rubber composition according to claim 16, wherein the rubber composition does not comprise an agent for coupling silica to a diene elastomer or comprises less than 0.5% by weight of an agent for coupling silica to a diene elastomer relative to the weight of silica in the composition.

29. A rubber article comprising the rubber composition according to claim 16.

30. A tire comprising the rubber composition according to claim 16, the rubber composition being present in at least one sidewall of the tire.
